(19) United States
(12) Patent Application Publication
(10) Pub. No.: US 2021/0166118 A1
(43) Pub. Date: Jun. 3, 2021

(54) DATA ANALYSIS SYSTEM, METHOD, AND PROGRAM

(71) Applicant: NIPPON TELEGRAPH AND TELEPHONE CORPORATION, Tokyo (JP)

(72) Inventors: Yuki KURAUCHI, Tokyo (JP); Takuya NISHIMURA, Tokyo (JP); Hiroshi KONISHI, Tokyo (JP); Hitoshi SESHIMO, Tokyo (JP)

(73) Assignee: NIPPON TELEGRAPH AND TELEPHONE CORPORATION, Tokyo (JP)

(21) Appl. No.: 17/048,539

(22) PCT Filed: Apr. 16, 2019
(86) PCT No.: PCT/JP2019/016327

§ 371 Date: Oct. 16, 2020

(30) Foreign Application Priority Data
Apr. 18, 2018 (JP) 2018-079775

(51) Int. Cl. G06N 3/08; G06N 3/04

(52) U.S. Cl. CPC G06N 3/08; G06N 3/04

(57) ABSTRACT

A data analysis system capable of performing appropriate analysis while reducing an amount of communication is provided.

The data analysis system (90) includes an instrument (10) that performs conversion processing of outputting low-dimensional observation data that is output of an intermediate layer acquired by processing, from the input layer to a predetermined intermediate layer, observation data received through an input layer of a trained neural network (18A) and a device (20) that performs analysis processing of inputting the low-dimensional observation data to an intermediate layer next to the predetermined intermediate layer, in a trained neural network (18B), and acquiring, as a result of analyzing the observation data, output of an output layer using the next intermediate layer and the output layer. The trained neural networks (18A, 18B) are configured such that the number of nodes in the predetermined intermediate layer is smaller than the number of nodes in the output layer and are pre-trained so that there is less overlap between probability distributions of the low-dimensional observation data, under a predetermined constraint, than when the predetermined constraint is not applied, for observation data having different analysis results.

### TECHNICAL FIELD

The present invention relates to a data analysis system, a method, and a program, and more particularly relates to a data analysis system, a method, and a program that analyzes observation data observed by an instrument such as a sensor.

### BACKGROUND ART

The number of Internet of Things (IoT) devices is predicted to increase further in the future (for example, see Non-Patent Literature 1). It is becoming important to achieve power saving in IoT devices due to the increase in number of IoT devices. In order to save power in IoT devices, technologies for reducing the power consumption of IoT devices have been proposed in, for example, Non-Patent Literature 2 and Non-Patent Literature 3.

In many cases, the purpose of installing an IoT device is to acquire not just detailed data acquired by the IoT device but an analysis result acquired from the detailed data (for example, see Non-Patent Literature 4). In order to perform more appropriate analysis, machine learning using, for example, a neural network is employed.

### CITATION LIST

### Non Patent Literature

Non-Patent Literature 1: “Ministry of Internal Affairs and Communications, White Paper on Information and Communications in Japan, 2015 Edition, Current Distinctive Changes in ICT”, http://www.soumu.go.jp/johotsusintokei/whitepaper/ja/h27/html/nc261120.html, viewed on 2018 Mar. 13

Non-Patent Literature 2: “Docomo, New Technology Enabling Reduction of Power Consumption of IoT Communication Devices by 1/5—CNET Japan”, https://japan.cnet.com/article/35107812/, viewed on 2018 Mar. 13

Non-Patent Literature 3: “Data Compression Technique to Achieve Low Power Consumption of IoT Terminal”, https://shingi.jst.go.jp/var/rev1/0000/1202/2016_osaka-u_1.pdf, viewed on 2018 Mar. 13

Non-Patent Literature 4: “Promotion of Integrated Next-Generation Agriculture Project using IT Fusion—Value Creation for Customer—Value Creation through Business”, https://www.ntt-west.cojp/csr/2015/valuable/customer/topics02.html, viewed on 2018 Mar. 13

### SUMMARY OF THE INVENTION

### Technical Problem

One example of a data analysis system employing machine learning using, for example, a neural network is a system including an instrument such as a sensor and a device such as a server computer. As illustrated in FIG. 11, the simplest method of transmitting observation data from an instrument to a device is a method in which the instrument transmits observation data with a large volume to the device without performing any processing other than compressing the observation data. In this case, the device obtains an analysis result by converting the received observation data into features and inference calculation using machine learning based on the converted features.

As illustrated in FIG. 12, another such method involves imparting a simple computation function to the instrument and having the instrument perform conversion to features and transmit the converted features to the device. In this case, the device obtains the analysis result through inference calculation using machine learning based on the received features. With this method, less data is communicated than when using the method illustrated in FIG. 11.

As illustrated in FIG. 13, yet another method involves the instrument transmitting, to the device, intermediate data acquired by inference calculation partway using machine learning. In this case, the device obtains the analysis result by resuming the inference calculation using machine learning from the received intermediate data. With this method, even less data is communicated than when using the method illustrated in FIG. 12.

However, the amount of communicated intermediate data described above is determined according to the number of nodes in an intermediate layer, and thus, it is conceivable that the amount of communication can be further reduced by reducing the number of nodes in the intermediate layer. On the other hand, reducing the number of nodes in the intermediate layer may cause more overlap between probability distributions of values output from the intermediate layer and cause expressive power to decrease, meaning that appropriate analysis cannot be performed. For this reason, it is preferable to perform appropriate analysis while reducing the amount of communication.

The present invention has been made in view of the circumstances described above, and an object of the present invention is to provide a data analysis system, a method, and a program capable of performing appropriate analysis while reducing the amount of communication.

### Means for Solving the Problem

In order to achieve the object described above, a data analysis system according to a first invention is a data analysis system including a device that analyzes observation data observed by an instrument, in which the instrument includes a converting unit that performs conversion processing of converting the observation data into low-dimensional observation data having a lower dimension than a dimension of the observation data, the conversion processing including outputting the low-dimensional observation data, the low-dimensional observation data being output of the predetermined intermediate layer acquired as a result of processing, from the input layer to a predetermined intermediate layer, the observation data received through an input layer of a pre-prepared trained neural network; the device includes an analysis unit that performs analysis processing of acquiring a result of analyzing the observation data from the low-dimensional observation data, the analysis processing including inputting the low-dimensional observation data to an intermediate layer next to the predetermined intermediate layer, and acquiring, as the result of analyzing the observation data, output of an output layer using the next intermediate layer and the output layer; and the trained neural network is configured such that the number of nodes in the predetermined intermediate layer is smaller than the number of nodes in the output layer, and the trained neural network is pre-trained so that there is less overlap between probability distributions of the low-dimensional observation data, under a predetermined constraint, than when the predetermined constraint is not applied, for observation data having different analysis results.

In addition, a data analysis system according to a second invention is the first invention, in which the trained neural network is configured such that, as the predetermined constraint, an intermediate layer previous to the predetermined intermediate layer includes a node that outputs an average of the low-dimensional observation data and a node that outputs a dispersion of the low-dimensional observation data, and output of the node that outputs the dispersion is multiplied by noise and used as input of the predetermined intermediate layer; and wherein the trained neural network is pre-trained using observation data with known analysis results, as training data, the observation data being different from the observation data to be analyzed.

In addition, a data analysis system according to a third invention is the second invention, in which the converting unit outputs the low-dimensional observation data by using the output of the node that outputs the average in the intermediate layer previous to the predetermined intermediate layer in the trained neural network as output of the predetermined intermediate layer.

In order to achieve the object described above, a data analysis method according to a fourth invention is a data analysis method using a data analysis system including a device that analyzes observation data observed by an instrument, the data analysis method including: performing conversion processing of converting the observation data into low-dimensional observation data having a lower dimension than a dimension of the observation data, the conversion processing including outputting the low-dimensional observation data, the low-dimensional observation data being output of the predetermined intermediate layer acquired as a result of processing, from the input layer to a predetermined intermediate layer, the observation data received through an input layer of a pre-prepared trained neural network; and performing analysis processing of acquiring a result of analyzing the observation data from the low-dimensional observation data, the analysis processing including inputting the low-dimensional observation data to an intermediate layer next to the predetermined intermediate layer, and acquiring, as the result of analyzing the observation data, output of an output layer using the next intermediate layer and the output layer, wherein the trained neural network is configured such that the number of nodes in the predetermined intermediate layer is smaller than the number of nodes in the output layer, and the trained neural network is pre-trained so that there is less overlap between probability distributions of the low-dimensional observation data, under a predetermined constraint, than when the predetermined constraint is not applied, for observation data having different analysis results.

Further, in order to achieve the object described above, a program according to a fifth invention causes a computer to function as the converting unit and the analysis unit included in the data analysis system of one of the first to third inventions.

### Effects of the Invention

As described above, with the data analysis system, method, and program according to the present invention, appropriate analysis can be performed while reducing the amount of communication.

### BRIEF DESCRIPTION OF DRAWINGS

FIG. 1 is a block diagram illustrating an example of the functional configuration of a data analysis system according to an embodiment.

FIG. 2 is a diagram illustrating operation of an instrument and a device according to an embodiment.

FIG. 3 is a diagram illustrating trained neural networks according to an embodiment.

FIG. 4 illustrates graphs showing examples of estimation accuracy acquired when a technique according to an embodiment is applied to an image recognition task and a phoneme recognition task.

FIG. 5 is a sequence diagram illustrating an example of the flow of processing of a data conversion processing program and a data analysis processing program according to an embodiment.

FIG. 6 is a diagram illustrating data analysis processing using an instrument and a device according to an embodiment.

FIG. 7 is a block diagram illustrating an example of the functional configuration of a training device according to an embodiment.

FIG. 8 is a flowchart illustrating an example of the flow of processing of a training processing program according to an embodiment.

FIG. 9 is a diagram illustrating a neural network for learning according to an embodiment.

FIG. 10 is a diagram illustrating an example of probability distribution when a predetermined intermediate layer according to an embodiment has two nodes.

FIG. 11 is a diagram illustrating related art.

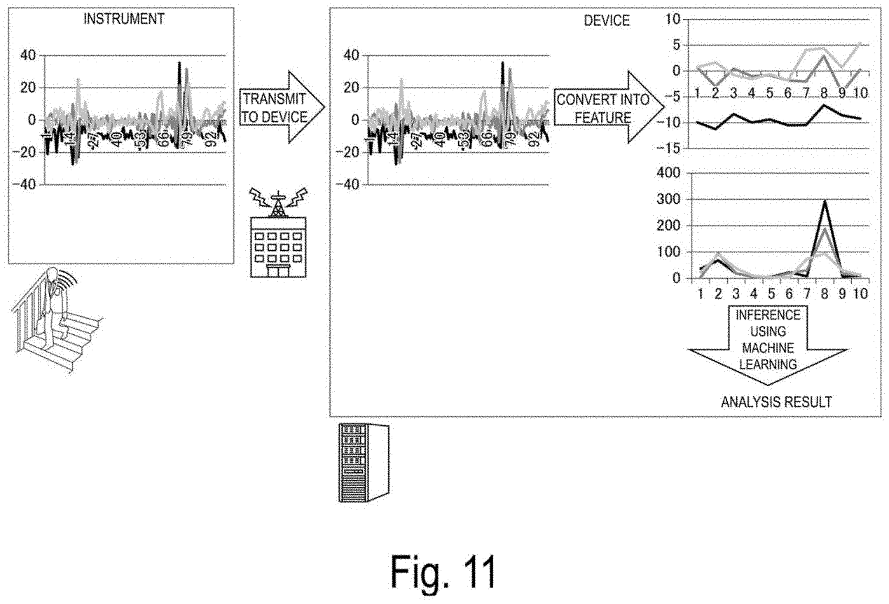

FIG. 12 is a diagram illustrating related art.

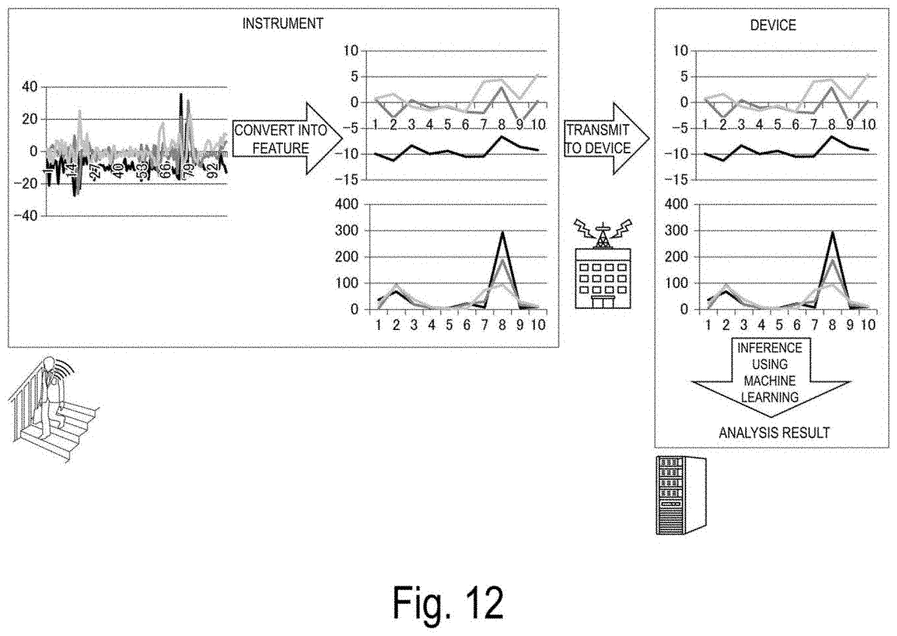

FIG. 13 is a diagram illustrating related art.

### DESCRIPTION OF EMBODIMENTS

Hereinafter, an exemplary embodiment of the present invention will be described in detail with reference to the drawings.

In this embodiment, an estimation-side data analysis system that includes an instrument such as a sensor and a device such as a server computer and analyzes data using a trained neural network will be described.

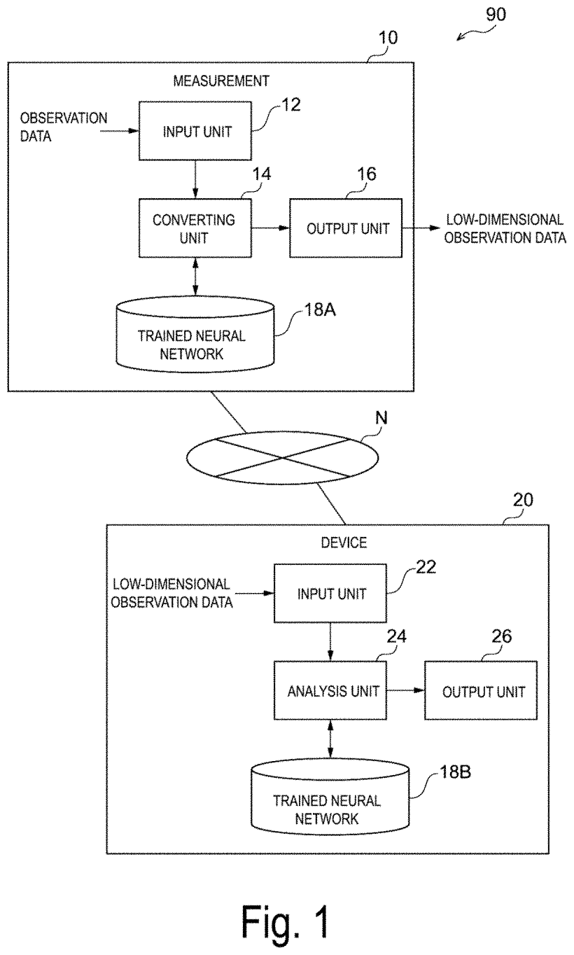

FIG. 1 is a block diagram illustrating an example of the functional configuration of a data analysis system 90 according to this embodiment.

As illustrated in FIG. 1, the data analysis system 90 according to this embodiment includes an instrument 10 and a device 20. The instrument 10 and the device 20 are communicatively connected via a network N.

The instrument 10 according to this embodiment is, for example, a sensor and is mounted to an object to be observed to acquire observation data from the object to be observed. The instrument 10 is electrically configured to include a central processing unit (CPU), a random access memory (RAM), a read only memory (ROM), and other components. The ROM stores a data conversion processing program according to this embodiment.

The data conversion processing program may be installed on the instrument 10 in advance, for example. The data conversion processing program may be embodied by being stored in a non-volatile storage medium, or by being distributed over a network and being installed on the instrument 10 as required. Examples of the non-volatile storage medium include a compact disc read only memory (CD-ROM), a magneto-optical disk, a digital versatile disc read only memory (DVD-ROM), a flash memory, and a memory card.

The CPU functions as an input unit 12, a converting unit 14, and an output unit 16 by reading and executing the data conversion processing program stored in the ROM. The ROM also stores a trained neural network (trained model) 18A. The trained neural network 18A included in the instrument 10 and a trained neural network 18B included in the device 20 to be described later are used to build one trained neural network (hereinafter referred to as “trained neural network 18”). More specifically, the one trained neural network 18 is divided at a predetermined intermediate layer (this intermediate layer will also be referred to as a hidden layer) The trained neural network 18A includes a portion from an input layer to the predetermined intermediate layer and the trained neural network 18B includes a portion from an intermediate layer next to the predetermined intermediate layer to an output layer.

The input unit 12 according to this embodiment receives input of observation data acquired from an object to be observed.

The converting unit 14 according to this embodiment performs conversion processing of converting the observation data input from the input unit 12 into low-dimensional observation data having a lower dimension than the dimension of the observation data. In this conversion processing, observation data is input to the input layer of the trained neural network 18A and is converted into the low-dimensional observation data using the portion from the input layer to the predetermined intermediate layer. In other words, the low-dimensional observation data is acquired as output of the predetermined intermediate layer in the trained neural network 18A.

The output unit 16 according to this embodiment transmits the low-dimensional observation data acquired by the converting unit 14 to the device 20 over the network N as output of the instrument 10.

The device 20 according to this embodiment is, for example, a server computer and is electrically configured to include a CPU, a RAM, a ROM, and other components. The ROM stores a data analysis processing program according to this embodiment. The data analysis processing program may be installed on the device 20 in advance, for example. The data analysis processing program may be embodied by being stored in a non-volatile storage medium, or by being distributed over a network and being installed on the device 20 as required.

The CPU functions as an input unit 22, an analysis unit 24, and an output unit 26 by reading and executing the data analysis processing program stored in the ROM. The ROM also stores the trained neural network (trained model) 18B.

The input unit 22 according to this embodiment receives input of the low-dimensional observation data output from the instrument 10.

The analysis unit 24 according to this embodiment performs analysis processing of obtaining a result of analyzing the observation data from the low-dimensional observation data input from the input unit 22. In this analysis processing, the low-dimensional observation data is input to an intermediate layer next to the predetermined intermediate layer, and output of the output layer is taken as a result of analyzing the observation data using a portion from the next intermediate layer to the output layer.

The output unit 26 according to this embodiment outputs the analysis result acquired by the analysis unit 24. For example, this analysis result is output to a display unit (not shown), a terminal device designated in advance, or the like.

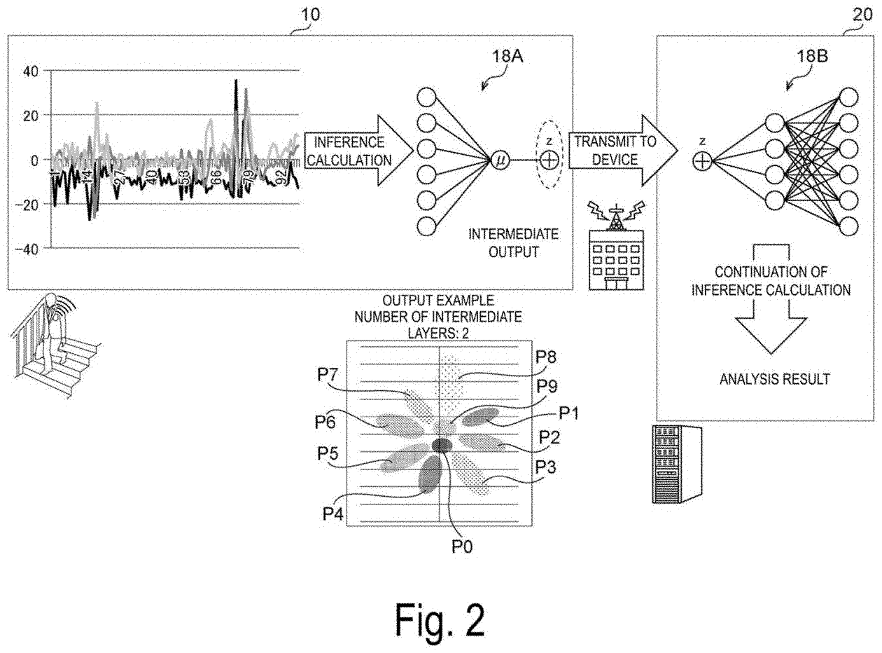

FIG. 2 is a diagram illustrating operation of the instrument 10 and the device 20 according to this embodiment.

As illustrated in FIG. 2, the instrument 10 transmits, to the device 20, low-dimensional observation data acquired by subjecting the input observation data to inference calculation partway using the trained neural network 18A. The device 20 continues the inference calculation using the trained neural network 18B with the received low-dimensional observation data as input to obtain an analysis result.

The trained neural network 18A according to this embodiment is configured such that the number of nodes in the predetermined intermediate layer is smaller than the number of nodes in the output layer (referred to as “Constraint 1”). The number of nodes in the predetermined intermediate layer is one or more. Here, one node corresponds to one dimension, and, in one example, one dimension is a real number represented in 32 bits. In addition, the trained neural network 18A is trained so that there is less overlap between probability distributions of low-dimensional observation data, under a predetermined constraint (referred to as “Constraint 2”), than when Constraint 2 is not applied, for pre-trained observation data having different analysis results acquired by the analysis unit 24.

More specifically, the trained neural networks 18A and 18B are trained in advance by a training device to be described later. A neural network for learning for training the trained neural networks 18A and 18B using the training device is configured such that, as the Constraint 2, an intermediate layer previous to the predetermined intermediate layer includes a node that outputs an average of the low-dimensional observation data and a node that outputs a dispersion of the low-dimensional observation data, and that output from the node that outputs a dispersion is multiplied by noise and used as input of the predetermined intermediate layer. The neural network for learning is pre-trained using observation data with known results of analysis (analysis results), as training data. The observation data is different from the observation data to be analyzed. In other words, correct labels indicating values by which images represented by training data are classified are assigned to the training data in advance. The neural network for learning to be described later is required to include the node that outputs an average and the node that outputs a dispersion. However, the trained neural network 18A is only required to include at least the node that outputs an average. Therefore, the example illustrated in FIG. 2 adopts a configuration that does not include the node that outputs a dispersion or a node that outputs noise.

The converting unit 14 according to this embodiment uses output from a node that outputs an average μ of the intermediate layer previous to the predetermined intermediate layer in the trained neural network 18A as output of the predetermined intermediate layer to output low-dimensional observation data. The output of this average μ is pre-trained so that there is less overlap between probability distributions of the low-dimensional observation data of observation data having different analysis results than when Constraint 2 is not applied. The example illustrated in FIG. 2 represents output of intermediate data when the number of nodes in the intermediate layer in the instrument 10 is “2”, and the reference signs P0 to P9 indicate probability distributions of the low-dimensional observation data.

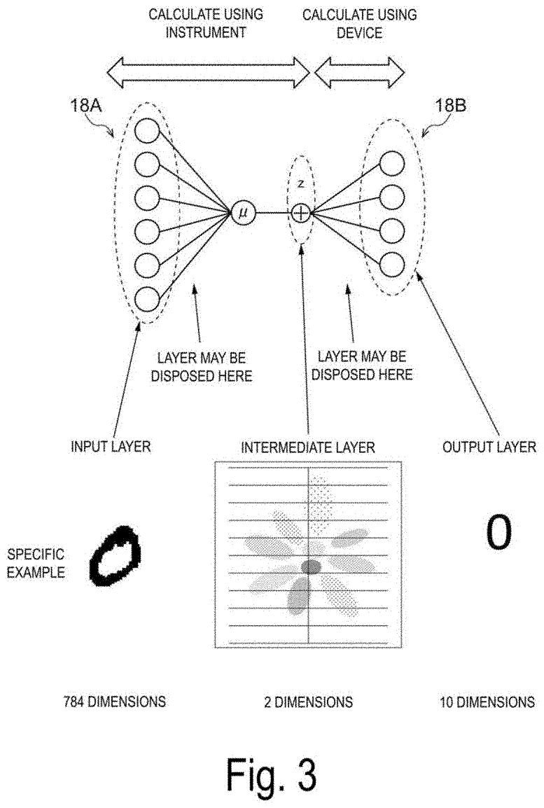

FIG. 3 is a diagram illustrating the trained neural networks 18A and 18B according to this embodiment.

As illustrated in FIG. 3, the trained neural network 18A according to this embodiment includes the portion from the input layer to the predetermined intermediate layer. The trained neural network 18B according to this embodiment includes a portion from an intermediate layer (not shown) next to the predetermined intermediate layer to the output layer.

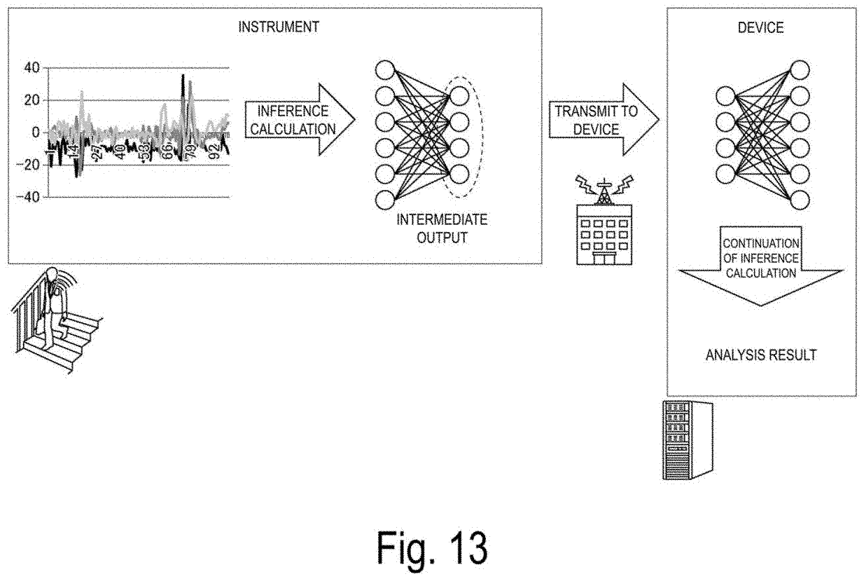

In other words, the observation data is input to the input layer of the trained neural network 18A, and the low-dimensional observation data is output from the predetermined intermediate layer. An output value of the predetermined intermediate layer is expressed as a variable Z representing output of the node that outputs the average μ. In the device 20, the variable Z received from the instrument 10 is input to the next intermediate layer of the learned neural network 18B, and output of the output layer is taken as an analysis result of the observation data using the portion from the next intermediate layer to the output layer. In this case, the instrument 10 only transmits the variable Z to the device 20 due to Constraint 1. Therefore, the amount of communication becomes smaller than in the related art illustrated in FIG. 13 described above. In addition, due to Constraint 2, there is less overlap between low-dimensional observation data than when Constraint 2 is not applied. Therefore, expressive power is prevented from decreasing even when there are less nodes due to Constraint 1.

In other words, in order to achieve the goal of acquiring a final appropriate analysis of expressive power with the number of nodes in the predetermined intermediate layer, the range in which probability distribution of values output from the predetermined intermediate layer overlap for each final analysis result is reduced.

In order to control the values output from the neural network for a final appropriate analysis, the related art describes a technique of changing weights of the intermediate layers. However, in this embodiment, a constraint is also applied to the values output from the intermediate layer, which is a distinctive point. For example, when determining whether certain observation data is normal or abnormal using, for example, a neural network, the network is trained such that data known to be normal is determined as normal, and data known to be abnormal is determined as abnormal. In other words, weights and other factors in the intermediate layer are learned by applying a constraint to the output from the output layer. In this embodiment, in addition to the constraint described above, a constraint is also applied to the predetermined intermediate layer. Referring to the example described above, weights and other factors in the intermediate layer are learned under the following constraints: data known to be normal is determined as normal, data known to be abnormal is determined as abnormal, the number of nodes in the predetermined intermediate layer, and probability distribution of the values output from the predetermined intermediate layer for data known to be normal, and probability distribution of the values output from the predetermined intermediate layer for data known to be abnormal overlap as little as possible.

Such a configuration is particularly effective when the number of nodes in the predetermined intermediate layer is smaller than the number of nodes in the output layer, that is, when there are many results to be analyzed. For example, in the case of character recognition, the technique is applied to determine the type of a character and a person who wrote the character from determination target data, rather than to determine the type of the character from the determination target data.

By using the trained neural network 18B according to this embodiment, a value having the highest probability from the low-dimensional observation data is output as an analysis result of the observation data. For example, as illustrated in FIG. 3, when an image of the observation data is a one-digit, handwritten number in 784 dimensions (“0” in the example illustrated in FIG. 3), the low-dimensional observation data to become the intermediate data is regarded as being in 2 dimensions, and the value having the highest probability (“0” in the example illustrated in FIG. 3) among 10 dimensional values from 0 to 9 is output according to the number of the observation data.

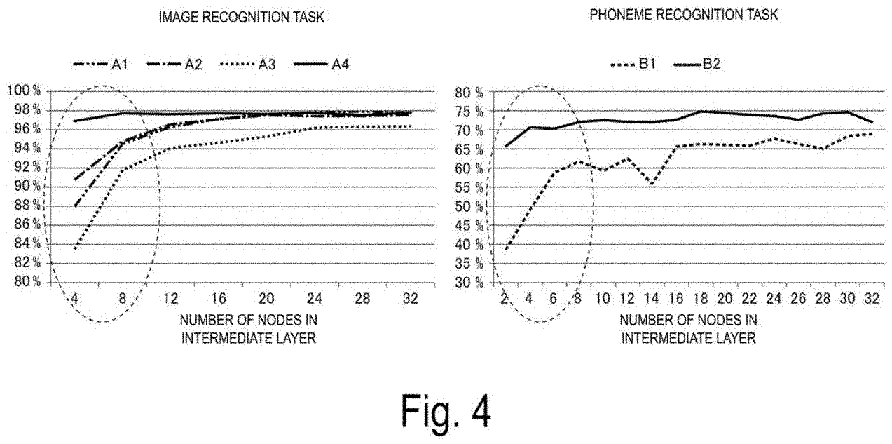

FIG. 4 illustrates graphs showing an example of estimation accuracy acquired when a technique according to this embodiment is applied to an image recognition task and a phoneme recognition task.

In the left graph (image recognition task) and the right graph (phoneme recognition task) of FIG. 4, the vertical axis represents estimation accuracy (with 100% as the highest), and the horizontal axis represents the number of nodes in the intermediate layer.

In the left graph of FIG. 4, the reference sign A1 represents a compressor using a deep neural network (DNN), the reference sign A2 represents a generation model of the compressor, the reference sign A3 represents a general DNN, and the reference sign A4 represents a DNN to which the technique according to this embodiment was applied.

In the right graph of FIG. 4, the reference sign B1 represents a general DNN and the reference sign B2 represents a DNN to which the technique according to this embodiment was applied.

With the technique according to this embodiment, estimation accuracy is improved over methods in the related art when the number of nodes in the intermediate layer is reduced in both cases illustrated in the left and right graphs of FIG. 4.

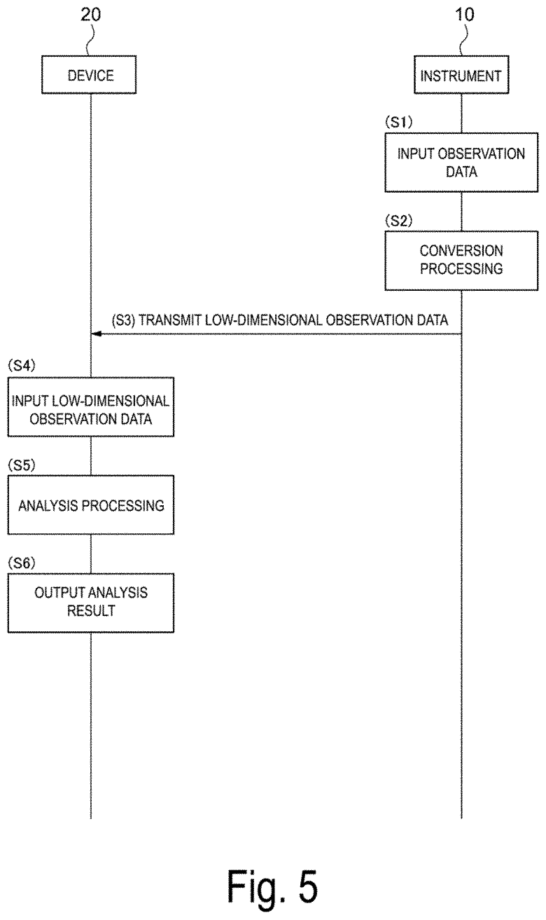

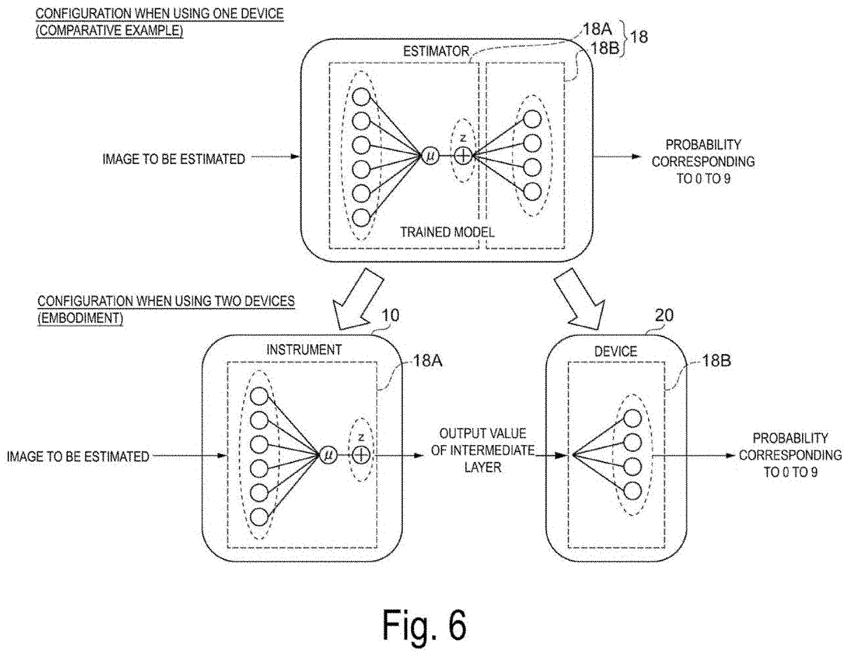

Next, operation of the data analysis system 90 according to this embodiment will be described with reference to FIG. 5 and FIG. 6. FIG. 5 is a sequence diagram illustrating an example of the flow of processing of the data conversion processing program and the data analysis processing program according to this embodiment. FIG. 6 is a diagram illustrating data analysis processing using the instrument 10 and the device 20 according to this embodiment.

In Step S1 of FIG. 5, the input unit 12 of the instrument 10 inputs an image to be estimated as observation data, as illustrated in “Configuration When Using Two Devices” in FIG. 6 as one example. As the image to be estimated in FIG. 6, for example, a hand-written image (“0” in the example in FIG. 3) formed as a 784-dimensional matrix illustrated in FIG. 3 is input. The “Configuration When Using One Device” in FIG. 6 is a comparative example.

In Step S2, the converting unit 14 of the instrument 10 uses the trained neural network 18A to convert the observation data input in Step S1 into low-dimensional observation data having a dimension lower than the dimension of the observation data (Constraint 1). In addition, because Constraint 2 is reflected in the trained neural network 18A, there is less overlap between probability distributions of the low-dimensional observation data than when Constraint 2 is not applied.

In Step S3, the output unit 16 of the instrument 10 transmits a value (variable Z) output from the predetermined intermediate layer as the low-dimensional observation data, acquired by converting the observation data in Step S2, to the device 20, as illustrated in “Configuration When Using Two Devices” in FIG. 6 as one example.

Next, in Step S4, the input unit 22 of the device 20 inputs the value (variable Z) output from the predetermined intermediate layer as the low-dimensional observation data transmitted from the instrument 10 in Step S3.

In Step S5, the analysis unit 24 of the device 20 analyzes the value output from the predetermined intermediate layer as the low-dimensional observation data input in Step S4 using the trained neural network 18B.

In Step S6, as illustrated in “Configuration When Using Two Devices” in FIG. 6 as one example, the output unit 26 of the device 20 outputs the analysis result acquired in Step S5 (“Probability corresponding to 0 to 9” in the example illustrated in FIG. 6) and ends the series of processes performed by the data conversion processing program and the data analysis processing program. Note that, as illustrated in FIG. 3, the value having the highest probability (“0” in the example illustrated in FIG. 3) among values in 10 dimensions from 0 to 9 may be finally output according to the number of the observation data.

Next, the training device for training the trained neural networks 18A and 18B used in the data analysis system 90 will be described.

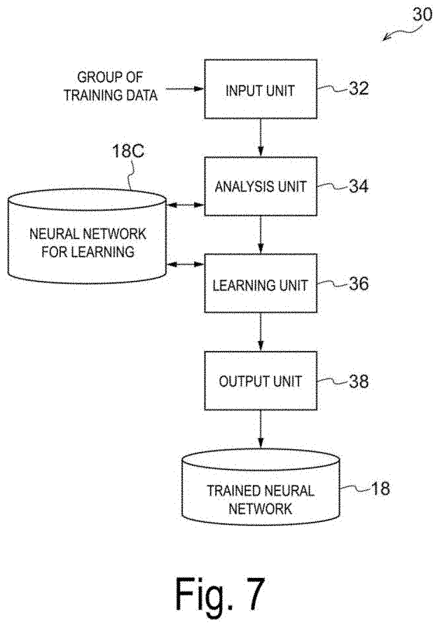

FIG. 7 is a block diagram illustrating an example of the functional configuration of a training device 30 according to this embodiment.

For example, a personal computer or a server computer is applied to the training device 30 according to this embodiment. The training device 30 may be implemented as one function of the above-described device 20 illustrated in FIG. 1. The training device 30 is electrically configured to include a CPU, a RAM, a ROM, and other components. The ROM stores a learning processing program according to this embodiment. This learning processing program may be installed on the training device 30 in advance, for example. The learning processing program may be embodied by being stored in a non-volatile storage medium, or by being distributed over a network and installed on the training device 30 as required.

The CPU functions as an input unit 32, an analysis unit 34, a learning unit 36, and an output unit 38 by reading and executing the learning processing program stored in the ROM.

The input unit 32 according to this embodiment receives input of a group of training data including a plurality of pieces of training data. The training data described here is different to the observation data to be analyzed and is observation data for which the analysis result is known.

The analysis unit 34 according to this embodiment performs processing of acquiring a result of analyzing the training data input from the input unit 32 using a neural network for learning 18C. In the neural network for learning 18C, conversion processing of converting the training data into low-dimensional training data having a dimension lower than the dimension of the training data is performed using the portion from the input layer to the predetermined intermediate layer. In this conversion processing, as Constraint 1, the training data is input to the input layer of the neural network for learning 18C, and the training data input from the input layer is converted into low-dimensional training data using the predetermined intermediate layer. In other words, the low-dimensional training data is acquired as output of the predetermined intermediate layer of the neural network for learning 18C. In the neural network for learning 18C, the number of nodes in the predetermined intermediate layer is smaller than the number of nodes in the output layer.

In the neural network for learning 18C, analysis processing of acquiring a result of analyzing the training data from the low-dimensional training data acquired in the predetermined intermediate layer is performed using a portion from an intermediate layer next to the predetermined intermediate layer to the output layer. In this analysis processing, the low-dimensional training data is input to the intermediate layer next to the predetermined intermediate layer, and output of the output layer is considered to be the analysis result of the training data.

In the learning unit 36 according to this embodiment, update processing of updating weights in the neural network for learning 18C is performed using the analysis result acquired by analyzing the training data with the analysis unit 34 and the correct labels assigned to the training data. At this time, the neural network for learning 18C is trained training so that there is less overlap between probability distributions of the low-dimensional training data of data having different analysis results as Constraint 2. More specifically, an intermediate layer previous to the predetermined intermediate layer includes a node that outputs an average of the low-dimensional training data and a node that outputs a dispersion of the low-dimensional training data, and output from the node that outputs a dispersion is multiplied by noise and used as input of the predetermined intermediate layer.

The output unit 38 according to this embodiment outputs the trained neural network 18 built from the neural network for learning 18C, which was obtained through the above-described training, to a storage unit or other device. For example, the trained neural network 18 excludes the node that outputs a dispersion and the node that outputs noise up to the intermediate layer previous to the predetermined intermediate layer from the neural network for learning 18C.

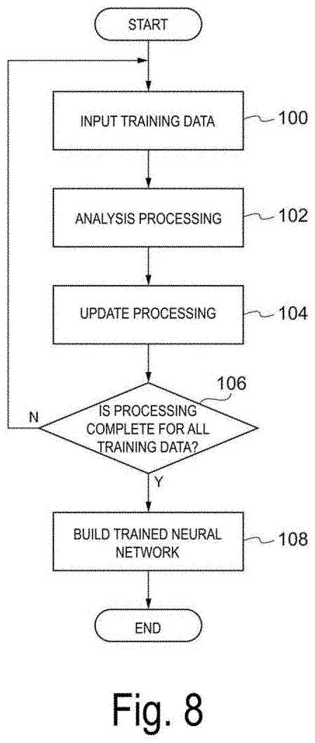

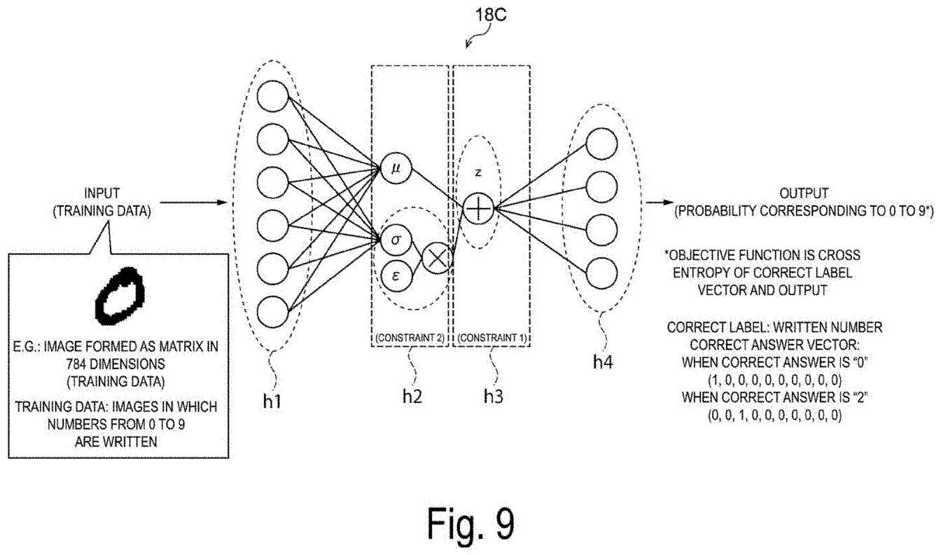

Next, operation of the training device 30 according to this embodiment will be described with reference to FIG. 8 and FIG. 9. FIG. 8 is a flowchart illustrating an example of the flow of processing of a learning processing program according to this embodiment. FIG. 9 is a diagram illustrating the neural network for learning 18C according to this embodiment.

In Step 100 of FIG. 8, the input unit 32 inputs training data to an input layer h1 of the neural network for learning 18C as illustrated in FIG. 9 as one example. FIG. 9 illustrates an exemplary problem of classifying an image in which a one-digit number is written into 10 values from 0 to 9 according to the written number. In this case, an image of handwriting (“0” in the example in FIG. 9) formed as a 784-dimensional matrix is input as the training data, for example.

In Step 102, as illustrated in FIG. 9 as one example, the analysis unit 34 converts the training data input to the input layer h1 in Step 100 into low-dimensional training data having a dimension lower than the dimension of the training data using a predetermined intermediate layer h3 as Constraint 1.

Then, in this Step 102, the analysis unit 34 performs analysis processing of acquiring a result of analyzing the training data from the low-dimensional training data acquired as described above. In this analysis processing, as illustrated in FIG. 9 as one example, the low dimensional-training data is input to an output layer h4 from the predetermined intermediate layer h3, and output from the output layer h4 is used as the result of analyzing the training data. In the example illustrated in FIG. 9, “Probability corresponding to 0 to 9” is output as an analysis result from the output layer h4 of the neural network for learning 18C.

In Step 104, the training unit 36 performs update processing of updating weights in the neural network for learning 18C using the analysis result acquired by analyzing the training data in Step 102 and the correct labels assigned to the training data. At this time, in the neural network for learning 18C, as Constraint 2, an intermediate layer h2 previous to the predetermined intermediate layer h3 includes a node that outputs an average μ of the low-dimensional training data and a node that outputs a dispersion 6 of the low-dimensional training data, and output of the node that outputs the dispersion 6 is multiplied by a noise c and used as input of the predetermined intermediate layer h3. In this Constraint 2, the value output from the predetermined intermediate layer h3 is generated from a normal distribution. With this Constraint 2, the training is performed such that there is less overlap between probability distributions of the low-dimensional training data than when Constraint 2 is not applied. This training is performed by minimizing an objective function set in advance based on the training data transmitted from the input layer h1. The objective function described here is represented as a cross entropy between a vector of the correct label and a vector of the output value of the predetermined intermediate layer h3.

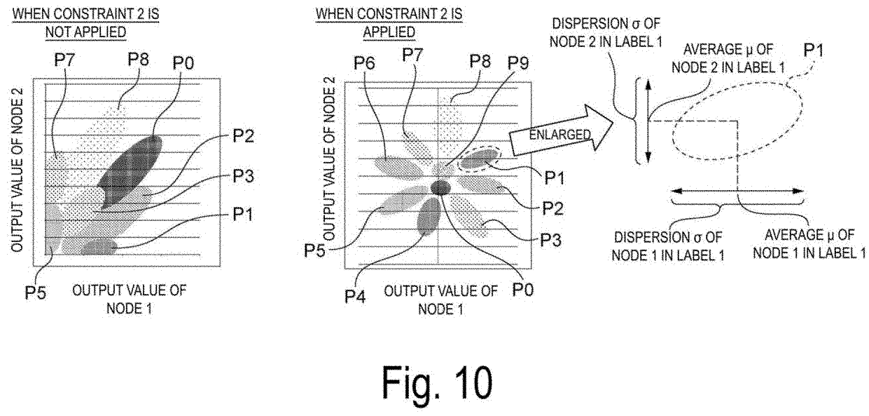

FIG. 10 is a diagram illustrating an example of probability distributions when the predetermined intermediate layer h3 according to this embodiment has two nodes.

The left graph of FIG. 10 shows probability distributions of the values output from a node 1 and the values output from a node 2 when Constraint 2 is not applied. The right graph of FIG. 10 shows probability distributions of the values output from the node 1 and the values output from the node 2 when Constraint 2 is applied. Probability distributions P0, P2, P3, P4, P5, P6, P7, P8, and P9 correspond to correct labels 0, 1, 2, 3, 4, 5, 6, 7, 8, and 9, respectively.

As shown in the left graph of FIG. 10, when the probability distributions of the correct labels 0 to 9 are plotted between the node 1 and the node 2, there is more overlap, and thus expressive power decreases. In contrast, as illustrated in the right graph of FIG. 10, when the distributions of the correct labels 0 to 9 are plotted between the node 1 and the node 2, there is less overlap than when Constraint 2 is not applied, and decrease in the expressive power is suppressed. In one example, the probability distribution P1 is illustrated in an enlarged manner and, under Constraint 2, the overlapping range is decreased by controlling the dispersion σ and the average μ of the output values. In other words, as described above, by multiplying the dispersion σ by the noise ε, the overlapping range is controlled to be small.

In Step 106, the output unit 38 determines whether processing has finished for all the training data. If it is determined that processing has finished for all the training data (determination of “Yes”), the processing proceeds to Step 108. If it is determined that processing has not finished for all the training data (determination of “No”), the processing returns to Step 100 and is repeated.

In Step 108, the output unit 38 builds the trained neural network 18 based on the neural network for learning 18C, outputs the trained neural network 18 that has been built to a storage unit or other device, and ends the series of processes performed by the training processing program.

The data analysis system and the training device have been described as examples of an embodiment. The embodiment may be in the form of a program that causes a computer to function as units of the data analysis system and the training device. The embodiment may be in the form of a computer-readable storage medium that stores this program.

In addition, the configurations of the data analysis system and the training device in the embodiment described above are examples and may be changed depending on circumstances within a range not departing from the gist of the invention.

Further, the flows of processing performed by the programs in the embodiment described above are also examples, and an unnecessary step may be deleted, a new step may be added, and the processing order of the steps may be changed within a range not departing from the gist of the invention.

In the embodiment described above, a case has been described where the processing according to the embodiment is executed by a software configuration using a computer by running a program, but the present invention is not limited thereto. The embodiment may be realized by, for example, a hardware configuration or a hardware configuration and a software configuration in combination.

### REFERENCE SIGNS LIST

10 Instrument
12 Input unit
14 Converting unit
16 Output unit
18, 18A, 18B trained neural network
18C Neural network for learning
20 Device
22 Input unit
24 Analysis unit
26 Output unit
30 Learning device
32 Input unit
34 Analysis unit
36 Learning unit
38 Output unit
90 Data analysis system

1.-5. (canceled)

6. A computer-implemented method for analyzing aspects of observation data, the method comprising:
receiving observation data;
providing the observation data to an input layer of a trained neural network, wherein the trained neural network includes the input layer, a plurality of intermediate layers, and an output layer in sequence, wherein the plurality of intermediate layers includes a first part of the plurality of intermediate layers and a second part of the plurality of intermediate layers, and wherein the last layer of the first part precedes the first layer of the second part in a sequence of the intermediate layers;
generating, based on the observation data using the first set of intermediate layers of the trained neural network, low-dimensional observation data, wherein the low-dimensional observation data is lower in dimension than the observation data, and wherein the low-dimensional observation data is an output of the last layer of the first part of the plurality of intermediate layers of the trained neural network; and
providing the low-dimensional observation data, wherein the provision of the low-dimensional observation data causes:
generating, using the low-dimensional observation data in the first layer of the second part and iteratively through the second part of the plurality of intermediate layers of the trained neural network, an output data of the trained neural network as an analysis result of the observation data; and
providing the analysis result of the observation data.

7. The computer-implemented method of claim 6, wherein the trained neural network includes a smaller number of nodes in the last layer of the first part of the plurality of intermediate layers than a number of nodes in the output layer, and wherein the trained neural network is configured to include a predetermined constraint such that an overlap of probability distributions between the low-dimensional observation data and another observation data with a different analysis result is less under the predetermined constraint than without the predetermined constraint.

8. The computer-implemented method of claim 7, wherein the predetermined constraint relates to the trained neural network configured to include the last layer of the first part of the plurality of intermediate layers comprising one or more nodes, wherein the one or more nodes generate average data and distribution data of the low-dimensional observation data, wherein the one or more nodes further generate, based on the distribution data and noise data, input data to the first layer of the second part of the plurality of intermediate layers of the trained neural network.

9. The computer-implemented method of claim 8, wherein the trained neural network is pre-trained using observation data with known analysis results, as training data, the observation data being different from the observation data to be analyzed.

10. The computer-implemented method of claim 8, wherein the low-dimensional observation data includes the average data based on the predetermined constraint.

11. The computer-implemented method of claim 7, the method further comprising:
receiving, by a sensor, the observation data;
transmitting, by the sensor, the low-dimension observation over a telecommunication network to a server, wherein the server is configured to generate the analysis result using the second part of the trained neural network.

12. The computer-implemented method of claim 9, wherein the observation data includes image data captured by an Internet of Things device, and wherein a first data volume of the observation data is more than a second data volume of the low-dimensional observation data.

13. A system for analyzing aspects of observation data, the system comprises:
a processor; and
a memory storing computer-executable instructions that when executed by the processor cause the system to:
receive observation data;
provide the observation data to an input layer of a trained neural network, wherein the trained neural network includes the input layer, a plurality of intermediate layers, and an output layer in sequence, wherein the plurality of intermediate layers includes a first part of the plurality of intermediate layers and a second part of the plurality of intermediate layers, and wherein the last layer of the first part precedes the first layer of the second part in a sequence of the intermediate layers;
generate, based on the observation data using the first set of intermediate layers of the trained neural network, low-dimensional observation data, wherein the low-dimensional observation data is lower in dimension than the observation data, and wherein the low-dimensional observation data is an output of the last layer of the first part of the plurality of intermediate layers of the trained neural network; and
provide the low-dimensional observation data, wherein the provision of the low-dimensional observation data causes to:
generate, using the low-dimensional observation data in the first layer of the second part and iteratively through the second part of the plurality of intermediate layers of the trained neural network, an output data of the trained neural network as an analysis result of the observation data; and
provide the analysis result of the observation data.

14. The system of claim 13, wherein the trained neural network includes a smaller number of nodes in the last layer of the first part of the plurality of intermediate layers than a number of nodes in the output layer, and wherein the trained neural network is configured to include a predetermined constraint such that an overlap of probability distributions between the low-dimensional observation data and another observation data with a different analysis result is less under the predetermined constraint than without the predetermined constraint.

15. The system of claim 14, wherein the predetermined constraint relates to the trained neural network configured to include the last layer of the first part of the plurality of intermediate layers comprising one or more nodes, wherein the one or more nodes generate average data and distribution data of the low-dimensional observation data, wherein the one or more nodes further generate, based on the distribution data and noise data, input data to the first layer of the second part of the plurality of intermediate layers of the trained neural network.

16. The system of claim 15, wherein the trained neural network is pre-trained using observation data with known analysis results, as training data, the observation data being different from the observation data to be analyzed.

17. The system of claim 15, wherein the low-dimensional observation data includes the average data based on the predetermined constraint.

18. The system of claim 14, the computer-executable instructions when executed further causing the system to:
receive, by a sensor, the observation data; and
transmit, by the sensor, the low-dimension observation over a telecommunication network to a server, wherein the server is configured to generate the analysis result using the second part of the trained neural network.

19. The system of claim 14, wherein the observation data includes image data captured by an Internet of Things device, and wherein a first data volume of the observation data is more than a second data volume of the low-dimensional observation data.

20. A computer-readable non-transitory recording medium storing computer-executable instructions that when executed by a processor cause a computer system to:
receive observation data;
provide the observation data to an input layer of a trained neural network, wherein the trained neural network includes the input layer, a plurality of intermediate layers, and an output layer in sequence, wherein the plurality of intermediate layers includes a first part of the plurality of intermediate layers and a second part of the plurality of intermediate layers, and wherein the last layer of the first part precedes the first layer of the second part in a sequence of the intermediate layers;
generate, based on the observation data using the first set of intermediate layers of the trained neural network, low-dimensional observation data, wherein the low-dimensional observation data is lower in dimension than the observation data, and wherein the low-dimensional observation data is an output of the last layer of the first part of the plurality of intermediate layers of the trained neural network; and
provide the low-dimensional observation data, wherein the provision of the low-dimensional observation data causes to:
generate, using the low-dimensional observation data in the first layer of the second part and iteratively through the second part of the plurality of intermediate layers of the trained neural network, an output data of the trained neural network as an analysis result of the observation data; and
provide the analysis result of the observation data.

21. The computer-readable non-transitory recording medium of claim 20, wherein the trained neural network includes a smaller number of nodes in the last layer of the first part of the plurality of intermediate layers than a number of nodes in the output layer, and wherein the trained neural network is configured to include a predetermined constraint such that an overlap of probability distributions between the low-dimensional observation data and another observation data with a different analysis result is less under the predetermined constraint than without the predetermined constraint.

22. The computer-readable non-transitory recording medium of claim 21, wherein the predetermined constraint relates to the trained neural network configured to include the last layer of the first part of the plurality of intermediate layers comprising one or more nodes, wherein the one or more nodes generate average data and distribution data of the low-dimensional observation data, wherein the one or more nodes further generate, based on the distribution data and noise data, input data to the first layer of the second part of the plurality of intermediate layers of the trained neural network.

23. The computer-readable non-transitory recording medium of claim 22, wherein the trained neural network is pre-trained using observation data with known analysis results, as training data, the observation data being different from the observation data to be analyzed.

24. The computer-readable non-transitory recording medium of claim 22, wherein the low-dimensional observation data includes the average data based on the predetermined constraint.

25. The computer-readable non-transitory recording medium of claim 21, the computer-executable instructions when executed further causing the system to:
receive, by a sensor, the observation data, wherein the observation data includes image data, and wherein a first data volume of the observation data is more than a second data volume of the low-dimensional observation data; and
transmit, by the sensor, the low-dimension observation over a telecommunication network to a server, wherein the server is configured to generate the analysis result using the second part of the trained neural network.
